(19) United States
(12) Patent Application Publication
(10) Pub. No.: US 2009/0139779 A1
(43) Pub. Date: Jun. 4, 2009

(54) Apparatus for inputting commands to a data processing installation

(76) Inventor: Willi Stahnke, Wollongong (AU)

Correspondence Address: COLLARD & ROE, P.C., 1077 NORTHERN BOULEVARD, ROSLYN, NY, 11576, US

(21) Appl. No.: 12/313,490

(22) Filed: Nov. 20, 2008

(30) Foreign Application Priority Data
Dec. 1, 2007 (DE) 10 2007 057 938.3

(51) Int. Cl. G06F 3/041

(52) U.S. Cl. 178/18.03

(57) ABSTRACT

The invention relates to an apparatus for inputting commands and the like to a data processing installation, in particular a minicomputer, having a sensor area, wherein the commands which can be input can be selected by touching the sensor area on different linear touching movements.

The invention relates to an apparatus for inputting commands and the like to a data processing installation, in particular a minicomputer, having a sensor area (touchpad).

Depending on the respective task to be carried out, various commands must be passed to a data processing installation. In the case of a word-processing package, these may be, for example, the letters of a word to be written, and/or characters from a set or formatting commands.

In principle, it is known for more or less extensive keyboards to be provided for the command input, although these present many people with handling difficulties, particularly when the keyboard, for example in the case of a minicomputer (for example a laptop) has very small dimensions and a large number of keys at the same time.

Furthermore, it is known for data processing installations to be provided with touch-sensitive image displays (touch screen) such that commands which are displayed on the image display can be selected and initiated by touching the image display at the point where the command is displayed. An arrangement such as this is comparatively complex on the one hand, and on the other hand has the disadvantage that the image display quickly becomes dirty. Apart from this, the respective user of the apparatus is not provided with good tactile monitoring of the command input.

In addition, it is known in principle for commands which can be entered to be displayed on the image display and to be selected by a cursor which moves on the image display. In this case, various options are known for cursor control. For example, the cursor can be moved by means of a so-called mouse or a trackball. Furthermore, it is known for a touch-sensitive sensor area (touchpad) to be provided for cursor control. When a finger (or a stylus) is moved along a touching movement on the sensor area, the cursor carries out a movement analogous to the touching movement, on the image display.

The cursor can possibly also be controlled by keys on a keyboard.

Command selection such as this by means of a cursor is comparatively difficult to carry out whenever a large number of commands which can be selected are displayed simultaneously on the image display.

The object of the invention is therefore to provide a novel apparatus, which can be handled easily, for inputting commands to data processing installations.

According to the invention, this object is achieved in that the commands which can be input can be selected by touching the sensor area on different linear touching movements.

The invention is based on the general idea of associating the respective commands which can be input with different linear touching movements on the sensor area. This allows fast and direct access to the individual commands.

According to one preferred embodiment of the invention, the commands which can in each case be selected are displayed on an image display in which case, in an expedient refinement of the invention, it is additionally possible for an indication of the associated touching movement also to be displayed in each case.

This provides the user with a neater form of guidance for his work.

According to a refinement of the invention which can be handled particularly easily, the sensor area may have a square field whose corners are provided as start and end groups of the touching movements, with the possible stroke directions running in the row, column or diagonal direction. In one physically simple refinement, the abovementioned field may have touch sensors arranged at its corners, so that touching movements which run in the row, column and/or diagonal direction always lead to operation of two touch sensors. If required, a further touch sensor can be provided in the field center, as a result of which touching movements which run in the diagonal direction can easily be sensed, even if they are not in each case carried out as far as the diagonally opposite corner.

In order to carry out the touching movements correctly, grooves can be formed on the field, in order to guide a finger or stylus.

Apart from this, with regard to preferred features of the invention, reference is made to the claims and the following explanation of the drawing, with reference to which one particularly preferred embodiment of the invention will be described in more detail.

Protection is claimed not only for the expressly stated or illustrated feature combinations but also for any desired combinations, in principle, of the stated or illustrated individual features.

In the drawing:

FIG. 1 shows a plan view of an image display area 1 of a minicomputer,

FIG. 2 shows a plan view of a control area 10 of the minicomputer, and

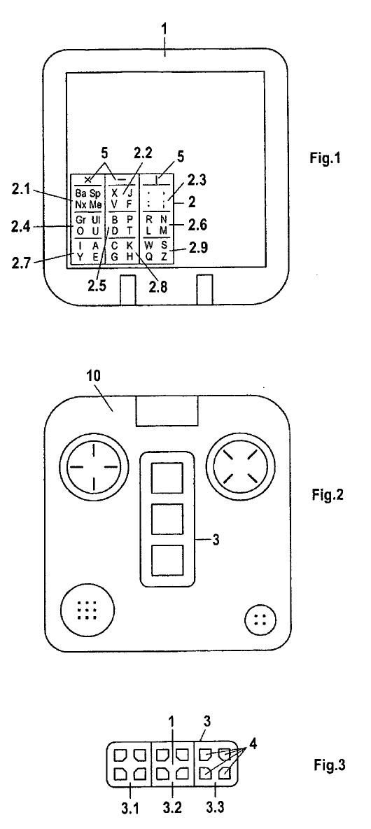

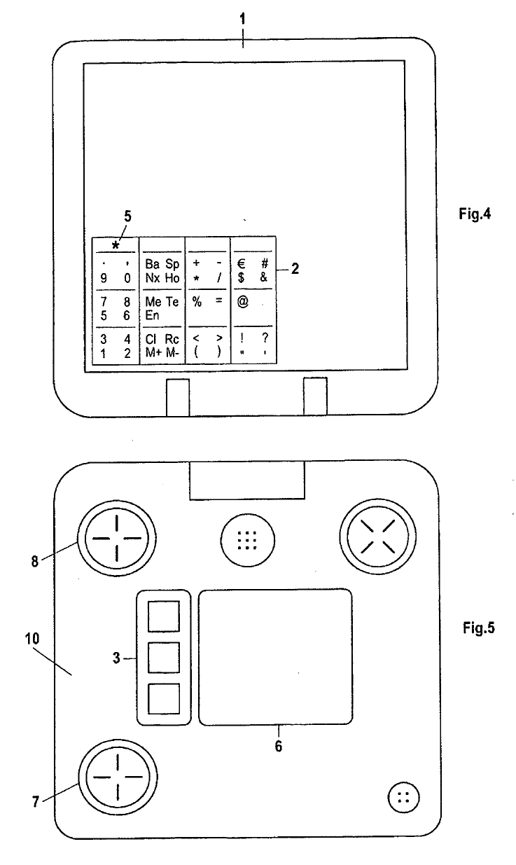

FIG. 3 shows a plan view, provided with details, of the sensor area 3 of the control area 10 in FIG. 2.

According to one preferred embodiment of the invention, commands which can be selected are in each case displayed on a display area part 2 of the image display area 1 illustrated in FIG. 1. The commands which can in each case be selected can be “scrolled through” by operating keys or the like on the control part 10 which is illustrated in FIG. 2, that is to say, in FIG. 1, just one example of a possible choice of commands is illustrated on the display area part 2.

In this case, the commands which can be selected are split between small sub-fields 2.1, 2.2 etc., which each show four commands which can be selected.

The commands which are displayed on the sub-fields 2.1, 2.2 etc. can be accessed directly in the manner described in the following text:

The sensor area 3 in FIG. 2 is used for this purpose. This sensor area is illustrated enlarged and with details in FIG. 3. As shown in FIG. 3, this sensor area 3 has three fields 3.1, 3.2 and 3.3, each having four touch sensors 4. In this case, the sensor field 3.1 is associated with the sub-fields 2.1 to 2.3 of the display area part 3. This sensor field 3.2 is associated with the sub-fields 2.4 to 2.6 of the display area part 2. The sensor field 3.3 is associated with the sub-fields 2.7 to 2.9 of the display area part 2. A stroke-like movement, touching the respective field, can be carried out with a finger or a stylus on each sensor field 3.1 to 3.3, during which movement two of the touch sensors 4 are in each case excited. By way of example, the finger or stylus can carry out a touching movement on the sensor area 3.2, leading from the top left touch sensor 4 in FIG. 3 in the “row direction” to the top right touch sensor 4. This results in the command “B” being selected on the sub-field 2.5 of the display area part 2 in FIG. 1. If the stroke direction is carried out in the opposite row direction, that is to say from the top right touch sensor 4 to the top left touch sensor 4 in the sensor field 3.2, the command “P” is selected in the sub-field 2.4. The command “D” is selected in the sub-field 2.5 by carrying out a stroke movement in the row direction on the sensor field 3.2, with this stroke movement leading from the bottom left touch sensor 4 to the bottom right touch sensor 4. The command “T” is selected in the sub-field 2.5 in FIG. 1 by the opposite stroke direction, that is to say when the touching movement leads from the bottom right touch sensor to the bottom left touch sensor 4 of the sensor field 3.2. The stroke direction, in this case the “row direction” results in conjunction with the sensor field 3.2 in the selection of the sub-field 2.5. The start point of the respective stroke determines the command selected from the sub-field 2.5. When strokes are carried out in the column direction on the sensor field 3.2, commands are automatically selected from the sub-field 2.6, with the respective start point of the respective stroke determining the respective command taken from the sub-field 2.6.

When diagonal strokes are carried out on the sensor field 3.2, commands are automatically selected from the sub-field 2.4 in FIG. 1, once again with the start point of the diagonal stroke determining the command taken from the sub-field 2.4.

In principle, it is also possible for the respective end point of a stroke movement to determine the command to be selected. However, it is generally more understandable and comprehensible for an operator for the selection of the respective command to be determined by the start point of a stroke movement. The important factor is that the stroke direction, that is to say the row direction, column direction or diagonal direction, results in a selection from the sub-fields (in this case by way of example: 2.4 to 2.6) associated with the respective sensor field (in this case for example: 3.2) in the display area part 2 of FIG. 1. Symbols 5 can in each case be provided above the columns of the sub-fields 2.1, 2.2 etc., indicating the respective stroke direction for the sub-fields of the respective column.

The various sensor fields 3.1 to 3.3 of the sensor area 3 are thus associated with different groups of sub-fields 2.1, 2.2, etc. which each appear in the display area part 4. Within these groups, the stroke direction of the touching movement which is carried out on the respective sensor field 3.1, 3.2 or 3.3 then determines the sub-field which is actually selected, with the start point of the respective touching movement then determining the selection of the command from the respectively selected sub-field.

In contrast to the illustration in FIG. 3, the sensor fields 3.1, 3.2 and 3.3 may each also have more than four touch sensors 4, in order that the stroke direction of the respective touching movement can be identified more quickly and reliably. In particular, there is then no need for the respective touching movement by the finger or stylus to be carried out completely between two corners of the respective sensor field 3.1, 3.2 or 3.3. It is then sufficient to carry out a movement element in each case.

Alternatively or additionally, modified control forms can also be provided:

If, for example in FIG. 1, the operator or the command “Nx” is selected in the field 2.4, the image display area 1 appears, as shown in FIG. 4. The cursor 15 can now be placed by means of the key 8 into one of the illustrated columns of the sub-fields which are illustrated in the field 2, as a result of which the sensor areas 3.1 to 3.3 of the sensor area 3 in FIG. 5 are associated with the corresponding sub-fields in that column of the field 2 which has been selected by the cursor 15. In the example shown in FIGS. 4 and 5, the number “7” is then selected in the central sub-field of the column under the cursor 15 in the display area part 2 of the image display area 1 in FIG. 4 by touching (by means of a stylus or the like) the top left corner of the sensor field 3.2, with the number “6” being selected in the above-mentioned sub-field by touching the right bottom corner of the sensor field 3.2, etc.

If required, a finger or stylus can also be moved on any desired path over a sensor field 6 in FIG. 5, and the cursor 15 in FIG. 4 then carries out an analogous movement and can thus be moved to any desired position on the image display area 1 in order to initiate an operator or command displayed there, or to control a game.

1. An apparatus for inputting commands and the like to a data processing installation, in particular a minicomputer, having a sensor area (3), wherein the commands which can be input can be selected by touching the sensor area (3) on different linear touching movements.

2. The apparatus as claimed in claim 1, wherein the sensor area (3) has a plurality of sensor fields 3.1 to 3.3).

3. The apparatus as claimed in claim 1, wherein the commands which can be selected are displayed on an image display (1).

4. The apparatus as claimed in claim 3, wherein symbols (5) for the stroke direction of the touching movement to be carried out in each case are displayed on the image display.

5. The apparatus as claimed in claim 1, wherein the sensor fields (3.1 to 3.3) are associated with different groups of the commands which can be selected and are displayed on the display area (1), with the stroke direction of a touching movement which is carried out on the respective sensor field determining a subgroup of the group associated with the respective sensor field of the commands which can be selected, and with the start point or end point of the touching movement, which is in the form of a stroke, determining the command which can be selected in the respective subgroup.

6. The apparatus as claimed in claim 1, wherein grooves are formed on the area of each sensor field, corresponding to the possible stroke directions of the touching movements.
